(19) United States
(12) Patent Application Publication
(10) Pub. No.: US 2026/0135127 A1
(43) Pub. Date: May 14, 2026

(54) BUBBLING HUMIDIFIER SUITABLE FOR HIGH-FLOW FUEL CELL TEST EQUIPMENT

(71) Applicant: Shandong Jianzhu University, Jinan (CN)

(72) Inventors: Xinhai LI, Jinan (CN); Ziyu XU, Jinan (CN); Zunjun BAO, Jinan (CN); Min YAN, Jinan (CN); Xiangan KONG, Jinan (CN); Yangyang LIU, Jinan (CN); Minglei LI, Jinan (CN)

(73) Assignee: Shandong Jianzhu University, Jinan (CN)

(21) Appl. No.: 19/438,027

(22) Filed: Dec. 31, 2025

(30) Foreign Application Priority Data
May 15, 2025 (CN) 202510624046.9

(51) Int. Cl. H01M 8/04119; H01M 8/04828

(52) U.S. Cl. CPC H01M 8/04149; H01M 8/04835

(57) ABSTRACT

Disclosed is a bubbling humidifier suitable for high-flow fuel cell test equipment, comprising an upper and lower tank, an aeration device and an anti-boiling device; wherein the upper tank and the lower tank are connected and the aeration device and the anti-boiling device are arranged inside the tank. The present disclosure adopts a bubbling humidifier suitable for a high-flow rate fuel cell test equipment, which uses circulating water to complete humidification of gas. effectively improving humidification while reducing humidifier dimensions, lowering production costs, and facilitating widespread adoption; the design of water inlet and water outlet pipelines slows down the flow of circulating water in the tank, reduces the disturbance of circulating water to gas, and improves the stability of the humidifier; the design of the anti-boiling device effectively prevents the water from rushing out of the tank when the gas flow rate is too high.

### TECHNICAL FIELD

The present disclosure belongs to the field of hydrogen fuel cell technology, specifically to a bubbling humidifier suitable for high-flow fuel cell test equipment.

### BACKGROUND

As a clean energy technology, fuel cell performance is highly dependent on the humidity level of the cathode air. To ensure optimal operation, precise humidity control is essential. The bubble humidifier, an efficient and stable humidification device, is widely used in fuel cell testing to supply air at the required humidity.

The Chinese utility model patent (Application No. 202220711300.0) discloses a spray-bubbling humidifier for fuel cell test equipment, which includes a tank and utilizes both bubbling and spraying humidification methods. However, this design has several shortcomings, first, the use of dual humidification methods results in a more complex structural layout, larger space requirements, and higher operating costs, which hinders its widespread adoption; second, the design fails to account for the impact of the water inlet and water outlet on the internal gas flow at the respective ports.

Therefore, this field needs to develop a bubbling humidifier suitable for high-flow fuel cell test equipment, this bubbling humidifier may effectively solve the above problems.

### SUMMARY

The purpose of the present disclosure is to provide a bubbling humidifier suitable for high-flow fuel cell test equipment. This humidifier employs a bubbling humidification method to humidity gas by means of water circulation. Through the incorporation of an aeration ring, the humidification performance is effectively improved while reducing the overall size of the unit, lowering production costs, and promoting widespread adoption. The design of the water inlet and outlet pipelines slows down the flow of circulating water inside the tank, minimizing disturbance to the gas and enhancing operational stability. Additionally, an anti-boiling device is implemented to effectively prevent water from being carried out of the tank when the gas flow rate becomes excessively high.

To achieve the above purposes, the present disclosure provides a bubbling humidifier suitable for high-flow fuel cell test equipment, including a tank, an aeration device and an anti-boiling device; the tank is composed of an upper tank and a lower tank, the upper tank and the lower tank are connected by a flange of the upper tank and a flange of the lower tank; the aeration device and the anti-boiling device are arranged inside the tank.

In some embodiments, a top of the upper tank is provided with a gas outlet of the tank, and the gas outlet of the tank is provided with a gas outlet flange of the tank;

a bottom of the lower tank has a drainage pipe of the tank, and a output end of the drainage pipe of the tank is provided with a flange of the drainage pipe.

In some embodiments, a side wall of the lower tank is provided with a water inlet of the tank, a water outlet of the tank, a gas inlet of the tank and a sensor mounting hole; a water inlet flange of the tank and a water outlet flange of the tank are respectively arranged at the water inlet of the tank and the water outlet of the tank.

In some embodiments, a water inlet ring is arranged inside the lower tank, water outlet channels are arranged on the water inlet ring, and water outlet channels are evenly distributed on the water inlet ring; the water inlet ring is connected to the water inlet of the tank.

In some embodiments, a bottom end of the tank is provided with a water outlet pipe, and an output end of the water outlet pipe is connected to the water outlet of the tank; a hemispherical protective cover is arranged at a connection between the water outlet pipe and the water outlet of the tank.

In some embodiments, an inner part of the tank is provided with the aeration device, and a bottom of the aeration device is provided with a first layer of an aeration ring and a second layer of the aeration ring from top to bottom;

the first aeration ring is connected to an aeration main pipe through a first fan-shaped connection surface; the second layer aeration ring is connected to the aeration main pipe through a second fan-shaped connection surface, and the fan-shaped connection surface of the aeration main pipe is provided with a bracket.

In some embodiments, an input end of the aeration main pipe is connected to a gas inlet of the tank; a diameter of a tail end of the aeration main pipe gradually becomes smaller from top to bottom, and the tail end ends in a spherical shape.

In some embodiments, the first layer of the aeration ring and the second layer of the aeration ring are provided with aeration holes;

a ratio of a cross-sectional area of the aeration main pipe to a total area of the aeration hole is 0.04-0.2; a flow rate of the aeration main pipe is reduced by 5 -25 times.

In some embodiments, the anti-boiling device is arranged inside the upper tank, the anti-boiling device is divided into four layers, namely a first layer of the anti-boiling plate, a second layer of the anti-boiling plate, a third layer of the anti-boiling plate, and a fourth layer of the anti-boiling plate; the two adjacent anti-boiling plates are connected by a fixed bracket; both the second layer of the anti-boiling plate and the fourth layer of the anti-boiling plate are provided with a gas circulation port.

In some embodiments, a bottom end of the anti-boiling device is provided with an isolation sleeve, and the anti-boiling device is connected to the inner of the tank through the isolation sleeve.

The present disclosure adopts a bubbling humidifier suitable for high-flow rate fuel cell test equipment, and the beneficial effects are as follows:
(1) Through the design of the aeration ring, the present disclosure effectively improves the humidification performance of the humidifier while reducing its overall dimensions, lowering production costs, and facilitating widespread adoption;
(2) Through the design of the water inlet and water outlet pipelines, the flow of circulating water in the tank is slowed down, the disturbance of circulating water to gas is reduced, and the stability of the humidifier is improved; the design of circulating water ensures the constant temperature of water inside the tank;
(3) The anti-boiling device of the bubbling humidifier is designed to prevent the water in a tube from rushing out of the tank with the gas when the gas flow rate is too fast, the anti-boiling device enables the excess water to reflow to the bottom of the tank along the anti-boiling plate through the outside of the isolation sleeve.

The following is a further detailed description of the technical schemes of the present disclosure through drawings and embodiments.

### BRIEF DESCRIPTION OF THE DRAWINGS

FIG. 1 is an overall schematic diagram of an embodiment of a bubbling humidifier suitable for high-flow fuel cell test equipment according to the present disclosure;

FIG. 2 is a back view of the embodiment of the bubbling humidifier suitable for high-flow fuel cell test equipment according to the present disclosure;

FIG. 3 is a front view and full section view of the embodiment of the bubbling humidifier suitable for high-flow fuel cell test equipment according to the present disclosure;

FIG. 4 is an overall full-section view of the embodiment of the bubbling humidifier suitable for high-flow fuel cell test equipment according to the present disclosure;

FIG. 5 is a structural schematic diagram of an aeration device of the embodiment of the bubbling humidifier suitable for high-flow fuel cell test equipment according to the present disclosure;

FIG. 6 is a structural schematic diagram of an anti-boiling device of the embodiment of the bubbling humidifier suitable for high-flow fuel cell test equipment according to the present disclosure.

Marks in the Figures

1, drainage pipe of the tank; 2, lower tank; 3, water inlet of the tank; 4, flange of the lower tank; 5, flange of the upper tank; 6, upper tank; 7, gas outlet of the tank; 8, gas inlet of the tank; 9, water outlet of the tank; 10, anti-boiling device; 11, isolation sleeve; 12, water inlet ring; 13, hemispherical protective cover; 14, flange of the drainage pipe; 15, water inlet flange of the tank; 16, gas outlet flange of the tank; 17, water outlet flange of the tank; 18, sensor mounting hole; 19, water outlet channel; 20, first layer of the aeration ring; 21, second layer of the aeration ring; 22, aeration pipe; 23, second fan-shaped connection surface; 24, first fan-shaped connection surface; 25, bracket; 26, first layer of the anti-boiling plate; 27, second layer of the anti-boiling plate; 28, third layer of the anti-boiling plate; 29, fourth layer of the anti-boiling plate; 30, fixed bracket; 31, gas circulation port; 32, aeration device.

### DETAILED DESCRIPTION OF THE EMBODIMENTS

The following is a further explanation of the technical scheme of the present disclosure through drawings and embodiments.

Unless otherwise defined, the technical terms or scientific terms used in the present disclosure should be understood by people with general skills in the field to which the present disclosure belongs.

### Embodiment

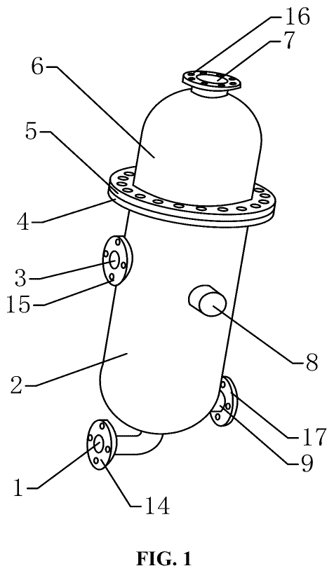

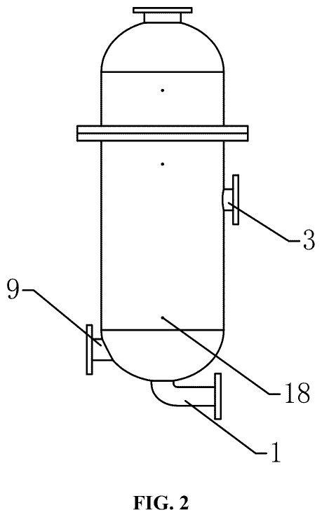

As shown in FIGS. 1-2, a bubbling humidifier suitable for high-flow fuel cell test equipment includes a tank, an aeration device 32, and an anti-boiling device 10. The tank is composed of an upper tank 6 and a lower tank 2, and the upper tank 6 and the lower tank 2 are connected by a flange of an upper tank 5 and a flange of the lower tank 4. The aeration device 32 and the anti-boiling device 10 are arranged inside the tank.

A top of the upper tank 6 is provided with a gas outlet of the tank 7, and the gas outlet of the tank 7 is provided with a gas outlet flange of the tank 16. There is a drainage pipe of the tank 1 at the bottom of the lower tank 2, and a output end of the drainage pipe of the tank 1 is provided with a flange of the drainage pipe 14. The side wall of the lower tank 2 is provided with a water inlet of the tank 3, a water outlet of the tank 9, a gas inlet of the tank 8, and a sensor mounting hole 18. The water inlet of the tank 3 and the water outlet of the tank 9 are respectively provided with the water inlet flange of the tank 15 and the water outlet flange of the tank 17.

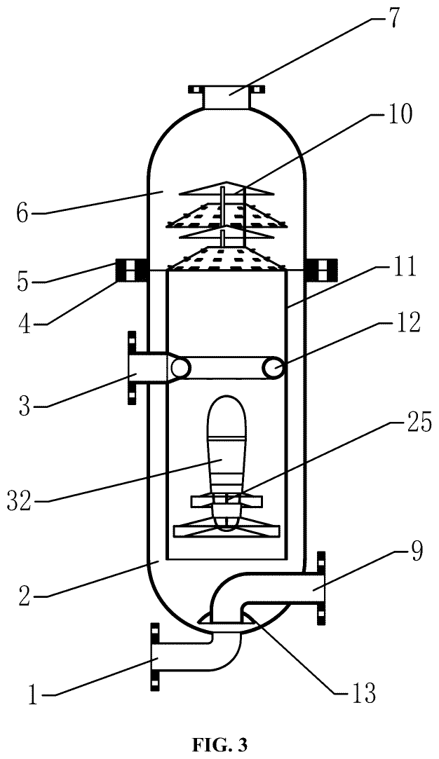

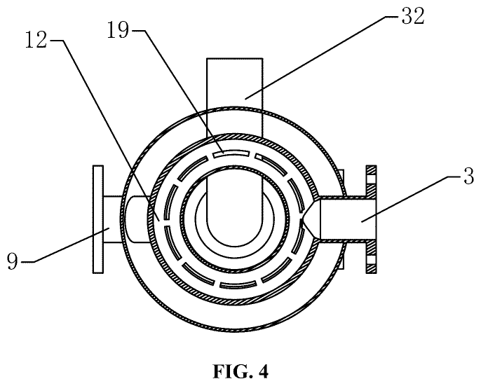

As shown in FIGS. 3-4, there is a water inlet ring 12 inside the lower tank 2, a water outlet channel 19 arranged on the water inlet ring 12, the water outlet channel 19 is evenly distributed on the water inlet ring 12, and the water inlet ring 12 is connected to the water inlet of the tank 3. Through the design of the water inlet ring 12 and the water outlet channel 19, the water flow velocity is reduced and the water flow direction is changed, the change in direction causes the water to flow vertically toward the bottom of the tank, avoiding the upward flow of gas, thereby weakening the influence of circulating water flow on gas humidification.

The bottom end of the lower tank 2 is provided with a water outlet pipe, and the output end of the water outlet pipe is connected to the water outlet of the tank 9. A hemispherical protective cover 13 is installed at the connection point between the water outlet pipe and the water outlet of the tank 9. This hemispherical protective cover 13 at the water outlet pipe end inside the water outlet of the tank 9 effectively prevents gas escaping from the aeration device 32 from flowing out through the water outlet of the tank 9.

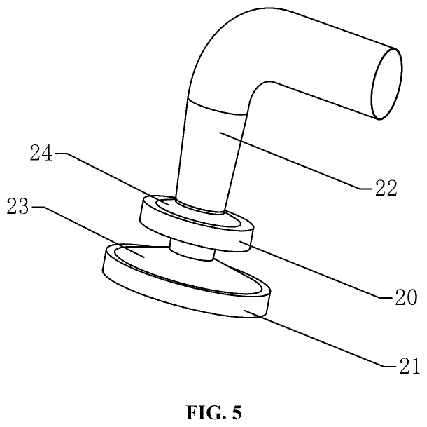

As shown in FIG. 5, there is an aeration device 32 inside the lower tank 2, and the bottom of the aeration device 32 is successively provided with a first layer of the aeration ring 20 and a second layer of the aeration ring 21 from top to bottom. the first layer of the aeration ring 20 is connected to the aeration main pipe 22 through a first fan-shaped connection surface 24. the second layer of the aeration ring 21 is connected to the aeration main pipe 22 through the second fan-shaped connection surface 23, and the fan-shaped connection surface of the aeration main pipe 22 is provided with a bracket 25 as a support. The aeration ring and the aeration main pipe 22 are connected by a fan-shaped connection surface, this way of connection may increase the gas flow rate.

There are aeration holes arranged on the first layer of the aeration ring 20 and the second layer of the aeration ring 21. The aeration holes have a large diameter and are sparsely distributed, while the smaller-diameter holes are densely distributed. To reduce the gas flow rate at the outlet of the aeration hole, the ratio of the cross-sectional area of the aeration main pipe 22 to the total area of the aeration hole is 0.04-0.2. Wherein the total area of the aeration hole is inversely proportional to the flow rate, and the flow rate of the aeration main pipe 22 is reduced by 5 -25 times.

The input end of the aeration main pipe 22 is connected to the gas inlet of the tank 8. The diameter of the tail end of the aeration main pipe 22 gradually becomes smaller from top to bottom, and its tail end ends in a spherical shape.

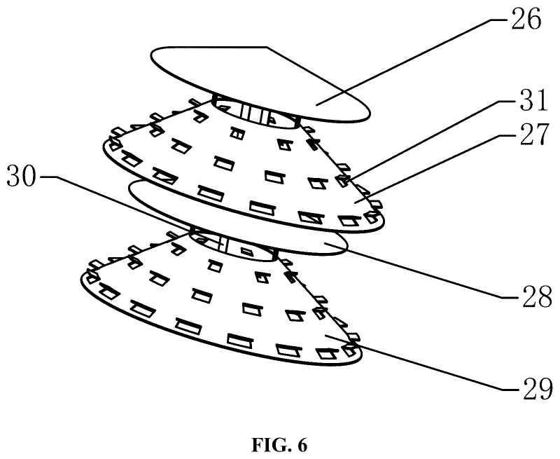

As shown in FIG. 6, there is an anti-boiling device 10 inside the upper tank 6, the anti-boiling device 10 is divided into four layers, including a first layer of the anti-boiling plate 26, a second layer of the anti-boiling plate 27, a third layer of the anti-boiling plate 28, and a fourth layer of the anti-boiling plate 29. The adjacent two layers of anti-boiling plates are connected by a fixed bracket 30. The second layer anti-boiling plate 27 and the fourth layer anti-boiling plate 29 are provided with a gas circulation port 31. The bottom of the anti-boiling device 10 is provided with an isolation sleeve 11, and the anti-boiling device 10 is connected to the inner of the tank through the isolation sleeve 11.

When the gas flow rate is too fast, the gas will rush to the anti-boiling plate with a part of water, blocked by the anti-boiling plate, and at the same time change the direction of the water flow, thereby the water flow under the action of gravity, the water flow along the edge of the anti-boiling plate through the outer wall of the isolation sleeve 11 flows back to the bottom of the tank, thus effectively avoiding the water with the gas rushed to the gas outlet of the tank 7, and then rushed out of the tank.

In the specific use of this embodiment, the required humidifying gas is first connected to the gas inlet of the tank 8, and the circulating water is connected to the water inlet of the tank 3 and the water outlet of the tank 9, respectively.

When working, the required humidifying gas enters from the gas inlet of the tank 8, flows through the aeration main pipe 22, the first fan-shaped connection surface 24, and the second fan-shaped connection surface 23, reaching the first layer of the aeration ring 20 and the second layer of the aeration ring 21, respectively. The gas flows out from the aeration hole on the aeration ring, flows through the circulating water for humidification, and finally flows out from the gas outlet of the tank 7.

The circulating water flows from the water inlet of the tank 3 into the water inlet ring 12, and then flows from the water outlet channel 19 on the water inlet ring 12 to the inside of the lower tank 2, and the circulating of the water circulation is realized by the water outlet of the tank 9.

When the gas flow rate is too fast, the gas will rush to the anti-boiling plate with a part of water, after being blocked by the anti-boiling plate, the water flows back to the bottom of the tank through the outer wall of the isolation sleeve 11 along the edge of the anti-boiling plate, and the gas flows to the required equipment through humidification along the gas outlet of the tank 7.

When the work is discontinued, the water inside the lower tank 2 is discharged from the drainage pipe of the tank 1.

Therefore, the present disclosure adopts a bubbling humidifier suitable for a high-flow rate fuel cell test equipment, adopts a bubbling humidification method, uses circulating water to complete the humidification of the gas, through the design of the aeration ring, effectively improves the humidification performance of the humidifier while reducing its overall dimensions, lowering production costs, and facilitating widespread adoption; the design of water inlet and water outlet pipelines slows down the flow of circulating water in the tank, reduces the disturbance of circulating water to gas, and improves the stability of the humidifier; the design of the anti-boiling device effectively prevents the water from rushing out of the tank when the gas flow rate is too high.

Finally, it should be noted that the above embodiments are only used to explain the technical solutions of the present disclosure rather than to restrict them. Although the present disclosure is described in detail with reference to the preferred embodiments, those of ordinary skill in the art should understand that they can still modify or equivalently substitute the technical solutions of the present disclosure, and these modifications or equivalent substitutions cannot make the modified technical solutions divorce from the spirit and scope of the technical solutions of the present disclosure.

What is claimed is:

1. A bubbling humidifier suitable for high-flow fuel cell test equipment, comprising a tank, an aeration device and an anti-boiling device, wherein: the tank is composed of an upper tank and a lower tank, the upper tank and the lower tank are connected by a flange of the upper tank and a flange of the lower tank, and the aeration device and the anti-boiling device are arranged inside the tank;
wherein an inner part of the tank is provided with the aeration device, and a bottom of the aeration device is provided with a first layer of an aeration ring and a second layer of an aeration ring from top to bottom; the first layer of the aeration ring is connected to an aeration main pipe through a first fan-shaped connection surface; the second layer of the aeration ring is connected to the aeration main pipe through a second fan-shaped connection surface, and the fan-shaped connection surface of the aeration main pipe is provided with a bracket; an input end of the aeration main pipe is connected to a gas inlet of the tank; a diameter of a tail end of the aeration main pipe gradually becomes smaller from top to bottom, and a tail end ends in a spherical shape;
wherein the first layer of the aeration ring and the second layer of the aeration ring are provided with aeration holes; a ratio of a cross-sectional area of the aeration main pipe to a total area of the aeration hole is 0.04-0.2, and a flow rate of the aeration main pipe is reduced by 5 -25 times;
and wherein the anti-boiling device is arranged inside the upper tank, the anti-boiling device is divided into four layers, namely a first layer anti-boiling plate, a second layer anti-boiling plate, a third layer anti-boiling plate, and a fourth layer anti-boiling plate;
wherein adjacent anti-boiling plates are connected by a fixed bracket and both the second layer anti-boiling plate and the fourth layer anti-boiling plate are provided with a gas circulation port.

2. The bubbling humidifier suitable for high-flow fuel cell test equipment according to claim 1, wherein a top of the upper tank is provided with a gas outlet of the tank, and the gas outlet of the tank is provided with a gas outlet flange;
and wherein a bottom of the lower tank has a drainage pipe, and a output end of the drainage pipe is provided with a flange.

3. The bubbling humidifier suitable for high-flow fuel cell test equipment according to claim 2, wherein a side wall of the lower tank is provided with a water inlet of the tank, a water outlet of the tank, a gas inlet and a sensor mounting hole; wherein a water inlet flange and a water outlet flange are respectively arranged at the water inlet and the water outlet.

4. The bubbling humidifier suitable for high-flow fuel cell test equipment according to claim 3, wherein a water inlet ring is arranged inside the lower tank, water outlet channels are arranged on the water inlet ring, and water outlet channels are evenly distributed on the water inlet ring; and the water inlet ring is connected to the water inlet of the tank.

5. The bubbling humidifier suitable for high-flow fuel cell test equipment according to claim 4, wherein a bottom end of the tank is provided with a water outlet pipe, and an output end of the water outlet pipe is connected to the water outlet of the tank; a hemispherical protective cover is arranged at a connection between the water outlet pipe and the water outlet of the tank.

6. The bubbling humidifier suitable for high-flow fuel cell test equipment according to claim 1, wherein a bottom end of the anti-boiling device is provided with an isolation sleeve, and the anti-boiling device is connected to the inner part of the tank through the isolation sleeve.
